(19) United States
(12) Patent Application Publication
(10) Pub. No.: US 2026/0180048 A1
(43) Pub. Date: Jun. 25, 2026

(54) A BATTERY MANAGEMENT MODULE

(71) Applicant: BAE SYSTEMS PLC, London (GB)

(72) Inventors: Benjamin Thomas Watson-Roalfe, Rochester, Kent (GB); Stanley John Roper, Rochester, Kent (GB)

(73) Assignee: BAE SYSTEMS PLC, London (GB)

(21) Appl. No.: 19/126,756

(22) PCT Filed: Nov. 3, 2023
(86) PCT No.: PCT/GB2023/052870

§ 371 Date: May 2, 2025

(30) Foreign Application Priority Data
Nov. 3, 2022 (GB) 2216357.0

(51) Int. Cl. H01M 10/44

(52) U.S. Cl. CPC H01M 10/441

(57) ABSTRACT

The invention relates to a battery management module, for interconnecting at least one battery and at least one charger, the battery management module having at least one battery monitoring hardware element. The battery management module arranged to charge and monitor a battery in a safety critical environment. The battery management module comprises: at least one safety parameter monitoring hardware element, each element generating a respective monitor output; and a hardware logic unit arranged to receive the respective monitor output and calculate a state output indicative of a state of a charger; wherein the hardware logic unit is configured to determine an operational status of the charger based on the output.

### FIELD

The present invention relates to a battery management system, in particular but not exclusively, to a module and a method for charging and monitoring a battery in a safety critical environment.

### BACKGROUND

Commercial Off-the-Shelf (COTS) battery chargers include and use both hardware and software components to manage charging of batteries. In particular, software components are used extensively as it provides a more flexible system. These COTS battery chargers generally operate in three stages for charging: a bulk stage, a boost and/or absorption stage and a float stage and these stages are supported by complex combination of software, firmware and hardware of the chargers. These COTS battery chargers in general are not designed for usage in a safety critical environment.

### SUMMARY

The invention is defined by the features of the appended claims.

According to an aspect of the invention there is provided a battery management module, for interconnecting at least one battery and at least one charger, the battery management module having at least one battery monitoring hardware element. The battery management module is arranged to charge and monitor a battery in a safety critical environment. The battery management module comprises: at least one safety parameter monitoring hardware element, each element generating a respective monitor output, a hardware logic unit arranged to receive the respective monitor output and calculate a state output indicative of a state of a charger; wherein the hardware logic unit is configured to determine an operational status of the charger based on the output.

In this way, the module provides charge current and voltage to the batteries completely through the use of simple hardware (e.g. a PCT comprising integrated circuits) without relying on software, microcode or firmware whilst monitoring battery and charger health parameters.

The at least one safety parameter monitoring hardware element may comprise one or more: a charger voltage monitor for monitoring the voltage being input and output to the charger; a charger current monitor for monitoring the current being input and output to the charger; a sub-rail voltage monitor for monitoring regulated power supply for the battery management module; a reference voltage monitor for monitoring reference voltage that is used for comparison with voltage that operates the monitors; and/or an input supply voltage monitor for monitoring total voltage being input to the battery management module.

In response to the hardware logic unit determining a fault from the state output, the operational status of the charger may be set to disengage; and a connection between the battery and the charger may be opened such that the charger is prevented from charging the battery.

Optionally, in response to the hardware logic determining no fault from the state output, the operational status of the charger is set to engage; and a connection between the battery and the charger is maintained such that the charger charges the battery.

The battery management module may be connectable to one or more batteries and one or more chargers, wherein each of the one or more batteries are connectable to respective one or more chargers and concurrently chargeable.

The one or more batteries may be connected in series.

The one or more chargers may be an isolated charger such that the one or more batteries are independently chargeable.

The battery management module may further comprise a latch; and at least one charger output switches. The latch may be configured to hold the at least one charger output switches in an open state for preventing the battery from being reconnected to a faulted charger.

The battery management module may further comprise a power-on latch reset circuit for preventing triggering of the latch for a predetermined period of time.

The safety critical monitors may be tested through in-service Initiated Built-In-Test. The battery management module may further comprise at least one Initiated Built-In-Test, IBIT, interlock hardware element for controlling engagement of a software operation.

Optionally, if the IBIT interlock hardware element is engaged, the status of the IBIT wraps back to the software operation for detecting an erroneous interlock operation.

The battery may monitor one or more hardware elements comprising one or more: a battery voltage monitor; a battery current monitor; and a battery temperature monitor.

The hardware logic unit may be implemented on a printed circuit board comprising one or more integrated circuits.

According to an aspect of the invention there is provided a method for interconnecting at least one battery and at least one charger using a battery management module, the battery management module having at least one battery monitoring hardware element. The battery management module is arranged to charge and monitor a battery in a safety critical environment. The method comprises: receiving by at least one safety parameter monitoring hardware element a respective monitor output, calculating at a hardware logic unit arranged to receive the monitor output a state output indicative of a state of a charger, a state output; and determining, via the hardware logic unit an operational status of the charger based on the state output.

The safety parameter monitoring elements may comprise one or more: a charger voltage monitor for monitoring the voltage being input and output to the charger; a charger current monitor for monitoring the current being input and output to the charger; a sub-rail voltage monitor for monitoring regulated power supply for the battery management module; a reference voltage monitor for monitoring reference voltage that is used for comparison with voltage that operates the monitors; and/or an input supply voltage monitor for monitoring total voltage being input to the battery management module.

The method may further comprise preventing the charger from charging the battery in response to the hardware logic determining a fault in the output and setting the operational status of the charger to disengage.

The method may further comprise charging the battery, in response to the hardware logic determining no fault in the output and setting the operational status of the charger to engage.

The method may further comprise controlling engagement of an Initiated Built-In-Test, IBIT, interlock by determining a status of the IBIT.

The method may further comprise wrapping the status of the IBIT back to the software operation for detecting an erroneous interlock operation, in response to engaging the IBIT interlock.

According to an aspect of the invention there is provided a battery for use with the battery management module according to any one of the preceding paragraphs.

According to an aspect of the invention there is provided a charger for use with the battery management module according to any one of the preceding paragraphs.

According to an aspect of the invention there is provided a battery management module configured to perform the method according to any one of the preceding paragraphs.

According to an aspect of the invention there is provided a battery management module according to any one of the preceding paragraphs is embodied in hardware on a printed circuit board comprising one or more integrated circuits.

According to an aspect of the invention there is provided a computer readable storage medium comprising instructions that, when executed, cause one or more processors to perform the method for a battery management module according to any one of the preceding paragraphs.

### BRIEF DESCRIPTION OF THE FIGURES

The invention will now be described by way of example only with reference to the figures, in which:

FIG. 1 is a block diagram that illustrates a charging architecture of a battery management module according to the present invention;

FIG. 2 is a block diagram that illustrates a monitoring architecture of a battery management module according to the present invention;

FIG. 3 is a flow chart of charging operation of the present invention; and

FIG. 4 is a flow chart of a method for charging and monitoring a battery according to the present invention.

### DETAILED DESCRIPTION

The present invention relates to a battery management module that is configured to charge a battery and monitor the charging process. The battery management module may charge and monitor a cell. The invention is described as using a battery management module for a battery, but the battery management module may be used for a cell or an energy storage of similar kind. The battery management system refers to an energy storage management module. A “cell” refers to an individual energy storage unit, while a “battery” refers to the entire power pack, comprising multiple cells in a series/parallel combination. While an individual cell produces only a few volts, a battery pack can be built up of dozens or more cells and deliver many tens of volts, and combinations of battery packs go even higher.

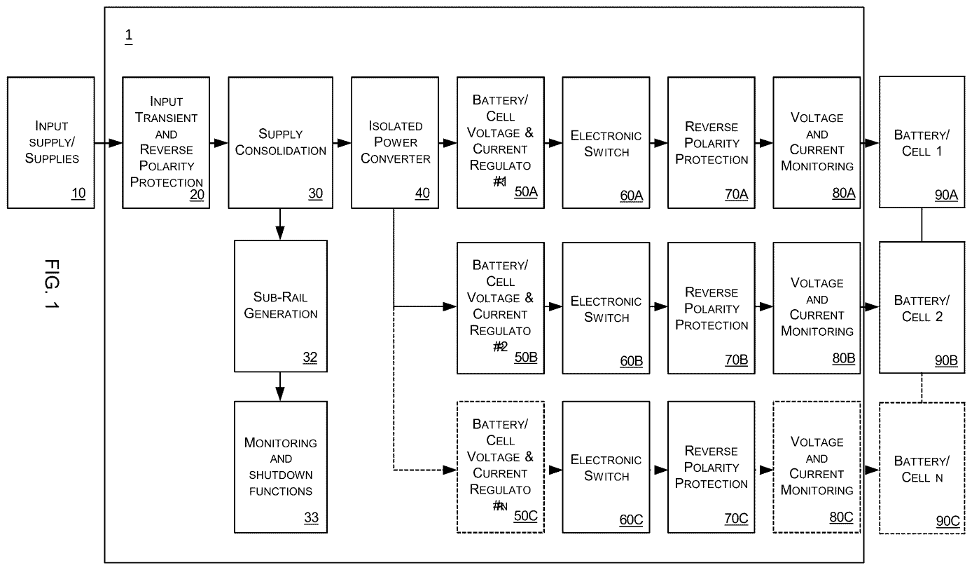

FIG. 1 illustrates an architecture of a battery management module 1 according to the present invention. The battery management module 1 of the present invention is a safety critical battery management system. FIG. 1 shows the battery management module 1 for charging and monitoring a battery 90A-C in a safety critical environment. The safety critical environment may comprise a harsh environment and/or a relatively inaccessible environment such as a sealed environment. Such environment may exist on a vehicle. The vehicle may be a terrain-based vehicle, a maritime vehicle or an aircraft. The battery management module 1 comprises at least one battery monitor hardware element 202, 204, 206 for monitoring a safety-relevant parameter. The battery monitor hardware element comprises a battery voltage monitor 202 arranged to calculate and monitor a battery voltage. Alternatively, or additionally the battery monitor hardware element comprises a battery current monitor 204 arranged to calculate and monitor a battery current. Alternatively, or additionally the battery monitor hardware element comprises a battery temperature monitor 206 arranged to calculate and monitor a battery temperature.

The battery management module 1 is arranged to connect to and receive power supply 10. The battery management module 1 comprises an input transient and reverse polarity protection circuit 20. The input transient and reverse polarity protection circuit 20 ensures that the battery management module 1 is not damaged if the input power supply polarity is reversed. The reverse polarity protection circuit may cut off power to the rest of the electronic circuits in the battery management module 1.

The battery management module 1 comprises a supply consolidation circuit 30 and a sub-rail (subordinate power supply rail) circuit 32. The sub-rail circuit 32 is a main power rail for all the functions operated from on the battery management module 1. The supply consolidation circuit 30 and the sub-rail circuit 32 are arranged to produce regulated voltage for the battery management module 1. The battery management module 1 comprises a monitoring and shutdown functions circuit 33 which monitors the sub-rail circuit 32. If the voltage from the sub-rail fails or fluctuates, then the battery management module 1 cannot guarantee that all the monitors 202, 204, 206, 210A-E arranged on the battery management module 1 are working properly. If the voltage from the sub-rail fails or drifts up or down, then the battery management module 1 is arranged to turn off the charger output. This prevents a catastrophic failure and ensures the safety of the vehicle.

The battery management module 1 comprises an isolated power converter 40. The isolated power converter 40 isolates the input from the output by electrically and physically separating the circuit into two or more sections preventing direct current flow between the input and the output of the charger. This also ensures that the chargers are isolated from each other so that each of the chargers are configured to independently charge the one or more batteries 90A-C. The battery management module 1 is connectable to one or more batteries 90A-C and one or more chargers. Each of the one or more batteries 90A-C are connectable to respective one or more chargers. For example, a separate charger is used for each battery within a two-battery stack. This allows for local charge current loops that only charge the battery that the charger is connected to. The battery management module 1 is scalable, allowing use of more stacked chargers. Additionally or alternatively, the one or more batteries are concurrently chargeable. Additionally or alternatively, the one or more batteries 90A-C are in series. The one or more batteries may be permanently in series.

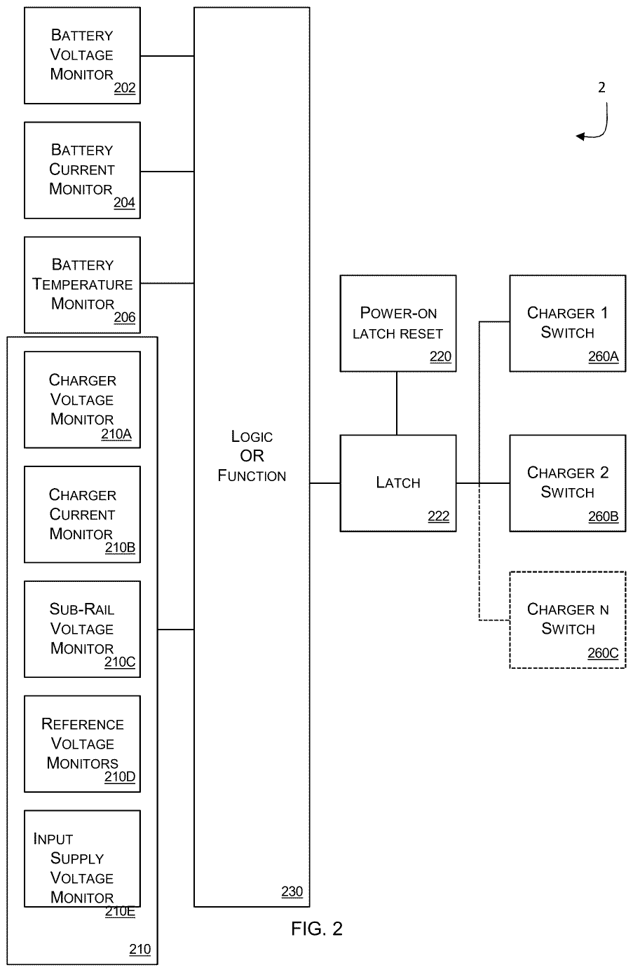

The battery management module 1 comprises a battery and/or cell voltage and current regulator circuit 50A-C. Depending on the number of chargers and batteries connected to the battery management module 1, the battery management module 1 comprises one or more battery and/or cell voltage and current regulators 50A-C. Each battery and/or cell voltage and current regulator circuit 50A-C is configured to monitor charger voltage and charger current. Each battery and/or cell voltage and current regulator circuit 50A-C regulates and provides correct and constant level of voltage and current to their respective battery and/or cell. Each battery and/or cell voltage and current regulator circuit 50A-C is configured to set the voltage and current to be appropriate for the battery chemistry. Additionally, the battery and/or cell voltage and current regulator circuit 50A-C comprises a charger voltage monitor 210A and a charger current monitor 210B illustrated in FIG. 2. The charger voltage and current monitoring is performed as part of the battery and/or cell voltage and current regulator circuit 50A-C, corresponding to the charger voltage monitor 210A and the charger current monitor 210B.

Each battery and/or cell voltage and current regulator circuit 50A-C can reduce ripple caused by spurious current bursts and isolate it from the rest of the electronics and circuits of the battery management module 1.

The battery management module 1 comprises an electronic switch 60A-C. The electronic switch 60A-C is configured to disconnect the one or more batteries 90A-C from the charger outputs. When a fault occurs, the isolated power converter 40 is switched off and the electronic switches 60A-C are made open circuit. This prevents the one or more batteries 90A-C from remaining electrically connected to a faulty charger. This also prevents discharging into the charger outputs to make the one or more batteries 90A-C last longer in the absence of the charger. The battery management module 1 comprises a reverse polarity protection 70A-70C. The reverse polarity protection 70A-70C is configured to provide protection for the charger outputs. If human error prevails and a battery/cell is connected in the incorrect polarity the reverse polarity protection 70A-70C ensures that the battery management module 1 is not damaged.

The battery management module 1 comprises one or more voltage and current monitoring circuits 80A-80C. The one or more voltage and current monitoring circuits 80A-80C is configured to monitor the battery voltage and battery charge current. Additionally, the one or more voltage and current monitoring circuits 80A-80C comprise a battery voltage monitor 202 and a battery current monitor 204 illustrated in FIG. 2. The battery voltage and current monitoring may be performed as part of the one or more voltage and current monitoring circuits 80A-80C, corresponding to the battery voltage monitor 202 and the battery current monitor 204. The voltage monitored by the charger voltage monitor 210A and the voltage monitored by the battery voltage monitor 202 substantially aligns. If they do not substantially align, then a fault is present. The current monitored by the charger current monitor 210B and the battery current monitor 204 substantially aligns. If they do not substantially align, then a fault is present. The battery management module 1 is connectable and operable with different types of batteries. A battery and/or a cell 90A-C is connectable to a charger via the battery management module 1. The battery may be a lead acid battery or a lithium battery. Depending on the type of the batteries, the battery management module 1 may change the values of the terminal voltage feedback network to adjust the terminal voltage target level. At least one safety critical monitor hardware element 210, as shown in FIG. 2, provides a simple hardware mechanism that aids in ensuring safe charging operation of batteries with volatile chemistries such as Lithium.

FIG. 2 illustrates a monitoring architecture 2. The battery management module 1 comprises at least one safety critical monitor hardware element 210 for monitoring state of a charger. The at least one safety critical monitor hardware element 210 corresponds with a hardware logic unit 230 to calculate an output indicative of the state of the charger. The safety critical monitor hardware elements 210 may comprise at least one of: a charger voltage monitor 210A for monitoring the voltage being input and output to the charger; a charger current monitor 210B for monitoring the current being input and output to the charger; a sub-rail voltage monitor 210C for monitoring regulated power supply for the battery management module; a reference voltage monitor 210D for monitoring reference voltage that is used for comparison with voltage that operates the monitors; and an input supply voltage monitor 210E for monitoring total voltage being input to the battery management module. Depending on the design choice, the safety critical monitor hardware elements 210 may comprise one or more of the safety critical monitors 210A-E shown in FIG. 2 forming various combination of the safety critical monitors on the battery management module 1. The safety critical monitors 210A-E provide health parameters for making decision on whether to disengage and/or disconnect the batteries from the charger. Additionally, the at least one safety critical monitor hardware element 210 provides access to diagnostic information. Additionally, the charger voltage monitor 210A and the charge current monitor 210B correspond to the battery and/or cell voltage and current regulator circuit 50A-C.

The battery management module comprises a hardware logic unit 230 arranged to determine operational status of the charger based on the output indicative of the state of the charger. The output indicative of the state of the charger is based on the calculation of each of the safety critical monitor hardware elements 210 of the battery management module 1. If the health state of the safety critical battery management module 1, the health state of the charger and the health state of the battery are satisfactory, then the battery management module 1 is arranged to initiate or continue charging of the battery. This ensures that generation of the evolution of hydrogen gas which is undesirable and unsafe in the safety critical environment is prevented.

The hardware logic unit 230 of the battery management module 1 determines whether there is a fault in the output indicative of the state of the charger. For example, there is a fault if voltage monitored by the charger voltage monitor 210A and the voltage monitored by the battery voltage monitor 202 does not substantially align. Alternatively, or additionally, there is a fault if current monitored by the charger current monitor 210B and the battery current monitor 204 does not substantially align. In response to the hardware logic unit 230 determining a fault in the output, the operational status of the charger is set to disengage mode. The battery management module 1 prevents the charger from charging the battery (90A-C). The battery management module 1 may disengage with the battery and/or disconnect the battery so that the charging does not occur. In response to the hardware logic unit 230 determining no fault in the output, the operational status of the charger is set to engage mode. The battery management module 1 may initiate or continue charging the battery (90A-C). If the health state of the safety critical battery management module 1, the charger or the battery is unsatisfactory then the charging of the battery is terminated or does not start. This ensures that the generation of the evolution of hydrogen gas which is undesirable and unsafe in the safety critical environment is prevented. The battery management module 1 only operates to charge the battery when the health state of the battery and the charger acceptable to operate safely.

The hardware logic unit 230 may use logic OR. In a high-level safety critical situation, the battery management module 1 may, via the hardware logic unit 230, shut down the charger and disconnect the battery if a single fault is determined from any one of the safety critical monitors 210A-E and the battery monitors 202, 204, 206.

Additionally, the battery management module 1 may further comprise at least one Initiated Built-In-Test, IBIT, interlock hardware element for controlling engagement of a software operation. The IBIT interlock is configured to connect onboard bit stimulus devices to the at least one of the safety critical monitors 210A-E and the battery monitors 202, 204, 206. The onboard bit stimulus devices, not shown in Figures, comprise digital-to-analogue converters (DACs) optionally combined with a general-purpose input/output (GPIO). The IBIT interlock provides a mechanism to control the interference of software operation with the charging and/or shutdown status of the module. For example, the IBIT interlock prevents a fault on the bit stimulus devices causing a failure of a monitor, when the bit stimulus devices are connected into any one of the safety critical monitors 210A-E and the battery monitors 202, 204, 206 during a normal charging operation. The software operation does not interfere with the charging (i.e. in engage mode) and shutdown (i.e. in disengage mode) operational status of the charger without the IBIT interlock being set. If the IBIT interlock is engaged, then the status of the IBIT wraps back to the software operation for detecting an erroneous interlock operation. In this way erroneous serial bus operation is prevented from compromising the safety of the system. If erroneous interlock operation has been detected, then a user is notified. Additionally, the IBIT interlock is controllable by an external controlling function, such as a processor or a microcontroller.

Additionally, the battery management module 1 may further comprise a latch 222 and at least one charger output switches 260A-C. The latch 222 is configured to hold the at least one charger output switches 260A-C in an open state. The latch 222 holds the at least one charger output switches 260A-C opens when a fault has been detected. This ensures that the chargers do not reconnect with the one or more batteries 90A-C.

Additionally, the battery management module 1 may further comprise a power-on latch reset circuit 220, The power-on latch reset circuit 220 prevents triggering of the latch 222 for a predetermined period of time. The power-on latch reset circuit 220 prevents triggering of the latch 222 for an affirmative start-up of the battery management module 1.

For example, the predetermined period of time may be approximately 1 second. This allows all the safety critical monitors 210A-E to settle down upon connection. The predetermined period of time is adjustable depending on battery technology being used with the safety critical battery management module 1 and time constants involved in the unsafe failures of batteries 90A-C.

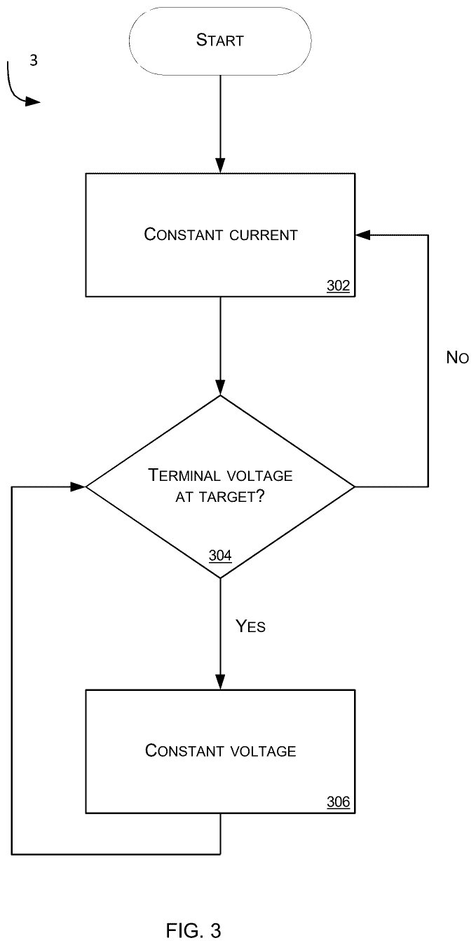

FIG. 3 is a flow chart of charging operation 3 of the present invention. The battery management module 1 is configured to determine constant provision of current at step 302. The battery management module 1 is configured to determine whether the terminal voltage is at target at step 304. Upon determining constant provision of the current and the terminal voltage being at target, the battery management module 1 is configured to initiate provision of constant voltage at step 306. The battery management module 1 is configured to disengage and/or disconnect a battery from the battery management module when the battery management module 1 determines that the constant current is not provided, or the terminal voltage is not at target. The battery management module 1 is configured to provide a bulk stage, step 302, and a float stage, step 306, of charging without boost and absorption stages.

The battery management module 1 is designed for charging and monitoring batteries installed in a relatively inaccessible environment. For example, the battery management module may be used for charging and monitoring lead-acid batteries within a sealed environment. The sealed environment is safety critical because it can trap the evolution of potentially explosive gases that can be created during charging of the batteries. Additionally, the battery management module 1 meets DO-254 standard Design Assurance Guidance for Airborne Electronic Hardware. For example, the battery management module 1 meets Design Assurance Level A of DO-254 standard Design Assurance Guidance. The battery management module 1 provides charge current and/or voltage to the batteries completely through the use of simple hardware without the use of software, microcode or firmware whilst monitoring battery and charger health parameters. Additionally, or alternatively, the battery management module 1 is embodied in hardware on a printed circuit board comprising one or more integrated circuits.

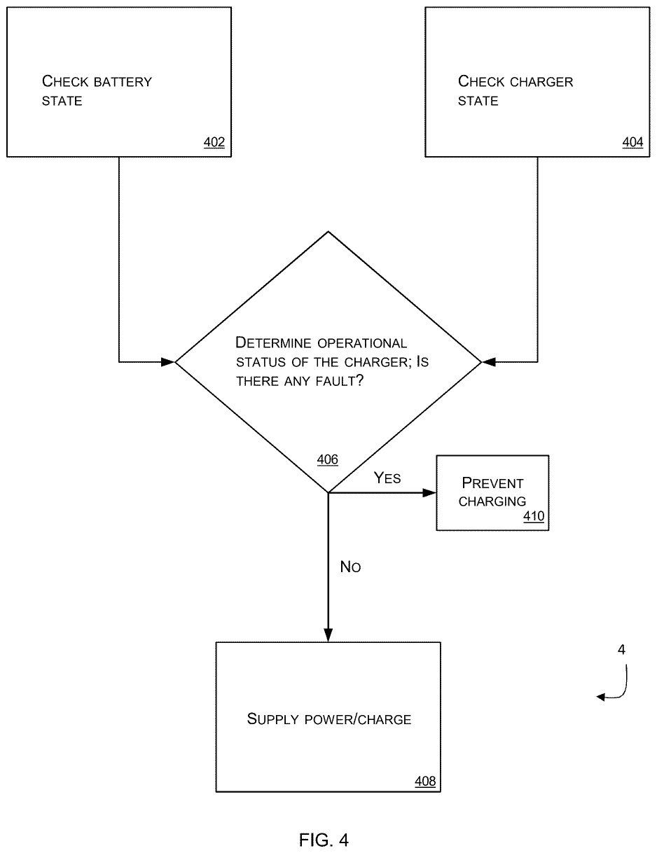

FIG. 4 illustrates a method 4 for charging and monitoring a battery or a cell. The battery management module 1 is configured to perform the method described in FIG. 4. At step 402, a state of a battery is checked. At step 404, a safety critical state is checked. These two steps 402 and 404 may run concurrently. The state of the battery is checked by monitoring one or more of: voltage of the battery, current of the battery and temperature of the battery. The monitoring is performed by individual hardware components. If any of the monitors 202, 204, 206, 210A-E shown in FIG. 2 output a signal indicating a fault then the battery management module 1 performs a preventive action. The preventive action comprises disengagement and/or disconnection of the battery and/or a shut-down of the charging circuit.

The method for a battery management module 1 having at least one battery monitor hardware element 202, 204, 206, the battery management module 1 arranged to charge and monitor a battery in a safety critical environment the battery management module 1, the method comprising: calculating a state output indicative of the state of a charger, at step 404. The at least one safety critical monitor hardware element 210 comprising hardware logic is arranged to calculate the state output. The method further comprises determining the operational status of the charger based on the state output, at step 406. A hardware logic unit 230 of the battery management module 1 is arranged to determine an operational status of the charger. The safety critical monitor elements 210 comprise at least one of: a charger voltage monitor 210A for monitoring the voltage being input and output to the charger; a charger current monitor 210B for monitoring the current being input and output to the charger; a sub-rail voltage monitor 210C for monitoring regulated power supply for the battery management module; a reference voltage monitor 210D for monitoring reference voltage that is used for comparison with voltage that operates the monitors; and/or an input supply voltage monitor 210E for monitoring total voltage being input to the battery management module.

The method further comprises determining, via the hardware logic unit 230, a fault in the state output. The method further comprises setting the operational status of the charger to ‘disengage’, in the event that a fault is determined to have occurred. Where an operational status is ‘disengage’, as shown at step 410, the charging of the battery 90A-C is prevented e.g. by opening a portion of circuitry otherwise connecting the battery and charger.

The method further comprises determining, via the hardware logic unit 230, no fault in the state output. The method further comprises setting the operational status of the charger to ‘engage’. At step 408, the charging operation of the battery 90A-C starts or continues e.g. a connection there between is maintained.

The method further comprises controlling engagement of an Initiated Built-In-Test, IBIT, interlock by determining a status of the IBIT.

The method further comprises wrapping the status of the IBIT back to the software operation for detecting an erroneous interlock operation, in response to engaging the IBIT interlock.

A computer readable storage medium comprising instructions that, when executed, cause one or more processors to perform the method for a battery management module 1 described within this application.

In situations where the safety level is less critical than others different numbers of monitors may be used. For example, for a critical safety environment all five safety critical monitors 210A-E described above may be used.

The present invention is described with reference to the figures and description, but it will be appreciated that scope of protection extends beyond the example shown and defined in the claim scope.

A particular reference to “logic” or logic units refers to a structure that performs a function or functions. An example of logic includes circuitry that is arranged to perform those function(s). For example, such circuitry may include transistors and/or other hardware elements available in a manufacturing process. Such transistors and/or other elements may be used to form circuitry or structures that implement and/or contain memory, such as registers, flip flops, or latches, logical operators, such as Boolean operations, mathematical operators, such as adders, multipliers, or shifters, and interconnect, by way of example. Such elements may be provided as custom circuits or standard cell libraries, macros, or at other levels of abstraction. Such elements may be interconnected in a specific arrangement. Logic may include circuitry that is fixed function and circuitry can be programmed to perform a function or functions; such programming may be provided from a firmware or software update or control mechanism. Logic identified to perform one function may also include logic that implements a constituent function or sub-process. In an example, hardware logic has circuitry that implements a fixed function operation, or operations, state machine or process.

The hardware logic unit may be comprised by relatively simple components, which can be take to be relatively reliable. For example the hardware logic may be comprised by fixed circuitry comprising or consisting of resistors, capacitors and diodes. Printed circuit boards and integrated circuits could be suitable.

Logic units such as programmable logic devices (PLDs) would not be considered to be sufficiently simple and robust for a safety critical environment.

1. A battery management module, for interconnecting at least one battery and at least one charger, the battery management module having at least one battery monitoring hardware element, the battery management module arranged to charge and monitor a battery in a safety critical environment, the battery management module comprising:
at least one safety parameter monitoring hardware element, each element generating a respective monitor output; and
a hardware logic unit arranged to receive the respective monitor output and calculate a state output indicative of a state of a charger, wherein the hardware logic unit is configured to determine an operational status of the charger based on the output.

2. The battery management module according to claim 1, wherein the at least one safety parameter monitoring hardware element comprises one or more of:
a charger voltage monitor for monitoring the voltage being input and output to the charger;
a charger current monitor for monitoring the current being input and output to the charger;
a sub-rail voltage monitor for monitoring regulated power supply for the battery management module;
a reference voltage monitor for monitoring reference voltage that is used for comparison with voltage that operates the monitors; and/or
an input supply voltage monitor for monitoring total voltage being input to the battery management module.

3. The battery management module according to claim 1, wherein in response to the hardware logic unit determining a fault from the state output, the operational status of the charger is set to disengage, and a connection between the battery and the charger is opened such that the charger is prevented from charging the battery.

4. The battery management module according to claim 1, wherein in response to the hardware logic unit determining no fault from the state output, the operational status of the charger is set to engage, and a connection between the battery and the charger is maintained such that the charger charges the battery.

5. The battery management module according to claim 1, wherein the battery management module is connectable to one or more batteries and one or more chargers, wherein each of the one or more batteries are connectable to respective one or more chargers and concurrently chargeable.

6. (canceled)

7. The battery management module according to claim 5, wherein the one or more chargers are an isolated charger such that the one or more batteries are independently chargeable.

8. The battery management module according to claim 1, further comprising:
a latch; and
at least one charger output-switches switch, wherein the latch is configurable to hold the at least one charger output switch in an open state for preventing the battery from being reconnected to a faulted charger.

9. The battery management module according to claim 82 further comprising: a power-on latch reset circuit for preventing triggering of the latch for a predetermined period of time.

10. The battery management module according to any one of the claim 1, wherein the safety parameter monitoring hardware elements are tested through in-service Initiated Built-In-Test.

11. The battery management module according to claim 1, further comprising at least one Initiated Built-In-Test, (IBIT) interlock hardware element for controlling engagement of a software operation.

12. The battery management module according to claim 11, wherein if the IBIT interlock is engaged and, then the status of the IBIT wraps back to the software operation for detecting an erroneous interlock operation.

13. The battery management module according to claim 1, wherein the battery monitoring hardware element comprises one or more:
a battery voltage monitor;
a battery current monitor; and
a battery temperature monitor.

14. (canceled)

15. A method for interconnecting at least one battery and at least one charger using a battery management module, the battery management module having at least one battery monitoring hardware element, the battery management module arranged to charge and monitor a battery in a safety critical environment, the method comprising:
receiving, by at least one safety parameter monitoring hardware element, a respective monitor output;
calculating, at a hardware logic unit arranged to receive the monitor output a state output indicative of a state of a charger, a state output; and
determining, via the hardware logic unit, an operational status of the charger based on the state output.

16. The method according to claim 15, wherein the safety parameter monitoring elements comprise one or more:
a charger voltage monitor for monitoring the voltage being input and output to the charger;
a charger current monitor for monitoring the current being input and output to the charger;
a sub-rail voltage monitor for monitoring regulated power supply for the battery management module;
a reference voltage monitor for monitoring reference voltage that is used for comparison with voltage that operates the monitors; and/or
an input supply voltage monitor for monitoring total voltage being input to the battery management module.

17. The method according to claim 15, further comprising:
preventing the charger from charging the battery, in response to the hardware logic unit determining a fault from the state output and setting the operational status of the charger to disengage.

18. The method according to claim 15, further comprising:
charging the battery, in response to the hardware logic unit determining no fault from the state output and setting the operational status of the charger to engage.

19. The method according to claim 15, further comprising:
controlling engagement of an Initiated Built-In-Test (IBIT) interlock by determining a status of the IBIT.

20. The method according to claim 19, further comprising:
wrapping the status of the IBIT back to the software operation for detecting an erroneous interlock operation, in response to engaging the IBIT interlock.

21. (canceled)

22. (canceled)

23. (canceled)

24. (canceled)

25. A non-transient computer readable storage medium comprising instructions that, when executed by one or more processors, cause a process for a battery management to be carried out, the process comprising:
receiving, by at least one safety parameter monitoring hardware element, a respective monitor output;
calculating, at a hardware logic unit arranged to receive the monitor output a state output indicative of a state of a charger, a state output; and
determining, via the hardware logic unit, an operational status of the charger based on the state output.

26. The non-transient computer readable storage medium according to claim 25, the process comprising:
preventing the charger from charging the battery, in response to the hardware logic unit determining a fault from the state output and setting the operational status of the charger to disengage;
charging the battery, in response to the hardware logic unit determining no fault from the state output and setting the operational status of the charger to engage;
controlling engagement of an Initiated Built-In-Test (IBIT) interlock by determining a status of the IBIT; and
wrapping the status of the IBIT back to the software operation for detecting an erroneous interlock operation, in response to engaging the IBIT interlock.
